(19) United States
(12) Patent Application Publication
(10) Pub. No.: US 2012/0118268 A1
(43) Pub. Date: May 17, 2012

(54) HIGH PRESSURE INJECTION SYSTEM HAVING FUEL COOLING FROM LOW PRESSURE REGION

(75) Inventors: Susanne Spindler, Stuttgart (DE); Jochen Walther, Ditzingen (DE); Dorothee Sommer, Stuttgart (DE); Stefan Kieferle, Stuttgart (DE)

(73) Assignee: ROBERT BOSCH GMBH, Stuttgart (DE)

(21) Appl. No.: 13/384,618

(22) PCT Filed: Jun. 8, 2010
(86) PCT No.: PCT/EP10/57966

§ 371 Date: Jan. 18, 2012

(30) Foreign Application Priority Data
Jul. 27, 2009 (DE) 102009028023.5

(51) Int. Cl. F02M 53/04; F02M 59/20

(52) U.S. Cl. 123/446

(57) ABSTRACT

The invention relates to a high pressure injection system having a fuel tank, a connection line between the fuel tank and a high pressure pump for sealing the fuel, wherein the high pressure pump is connected to at least one fuel injection valve via a corresponding connection line. According to the invention, at least a partial volume of the fuel sealed in the high pressure pump is fed back to the fuel tank from said fuel injection valve by leakage in the fuel injection valve via a return line connected to the fuel tank. An essential characteristic of the invention is that the high pressure injection system comprises a cooling line that connects the fuel tank or the low pressure region to the high pressure or a return of the high pressure pump via a mixing point with the return line. It is thereby possible to cool the fuel in the return lines between the fuel injection valve and the fuel tank.

### BACKGROUND OF THE INVENTION

The invention relates to a high pressure injection system, in particular to a high pressure reservoir injection system for internal combustion engines, having a fuel tank, from which the fuel is fed to the high pressure pump by means of a fuel feed pump and a line system. The compression of the fuel in the high pressure pump leads to a rise in the fuel temperature. The compressed fuel is fed through a further line by the high pressure pump into a high pressure reservoir, which, for its part, is connected at least to a fuel injection valve. During the operation of the internal combustion engine, compressed fuel is injected from the fuel injection valve into a combustion chamber. Part of the fuel fed to the fuel injection valve passes out of the fuel injection valve into the return line owing to leakage in the fuel injection valve or as a control quantity, wherein said leakage quantities are additionally heated through the relief of pressure as they flow through the fuel injection valve.

The invention is based on the insight that it is possible, in the case of unfavorable conditions (an almost empty fuel tank, a small volume of fuel which is frequently recirculated by the pump) and relevant load cases, for operating states to occur in which the fuel is heated beyond a permissible limiting temperature, resulting in decomposition (aging) of the fuel, which leads to a reduction in the lubricating properties of the fuel and hence to increased mechanical wear in the system. Moreover, the increased return temperatures may necessitate more expensive materials for the embodiment of the return lines.

In the injection system known, for example, from DE 10 2004 037 557 A1, the fuel is returned to the fuel tank without cooling, and this leads to a high temperature in the return. This necessitates correspondingly high-grade and expensive materials for the return lines and, under some circumstances, may lead to decomposition of the fuel, resulting in increased wear in the high pressure injection system.

KR-717316 B1 has disclosed high pressure injection systems with a separate cooling apparatus in the fuel return, but these lead to a large amount of additional design effort and to corresponding additional costs and, owing to their design, require a relatively large amount of installation space, the result being that such a solution cannot be implemented at every desired location in the engine compartment or leads to expensive redesign in the engine compartment.

### SUMMARY OF THE INVENTION

The invention makes it possible to reduce the disadvantages of an uncooled fuel return by simple and inexpensive means. For this purpose, a cooling line for adding fuel from cooler regions of the low pressure region is provided between the fuel tank and the high pressure pump, enabling cooler fuel to be added to the fuel return. As a result, the fuel temperature in the return is reduced and the abovementioned negative effects thus no longer occur or at least occur only to a significantly reduced extent.

A first illustrative embodiment of the fuel injection system is characterized in that the cooling line receives a volume flow required for fuel cooling between a fuel feed pump and the high pressure pump and feeds this volume flow to the leakage flow from the fuel injection valves, which can be embodied as common rail injectors for example, via a mixing point for the purpose of cooling. The fuel feed pump ensures that there is a volume flow at sufficient pressure for cooling purposes at all times and therefore this embodiment does not require additional regulating mechanisms. Another advantage of this embodiment is that the fuel feed pump eliminates the need for a pre-feed pump at the high pressure pump.

Another illustrative embodiment of the fuel injection system is characterized in that the cooling line receives a volume flow required for fuel cooling from the pre-feed pump arranged at the high pressure pump and feeds this volume flow to the leakage flow from the fuel injection valves via a mixing point. The pre-feed pump directly at the high pressure pump, which can be embodied as a gear pump for example, which draws in a volume flow from the fuel tank, eliminates the need for the fuel feed pump. The advantage of this embodiment is that the cooling line can be made correspondingly short and thus inexpensive.

Another illustrative embodiment of the fuel injection system is characterized in that the cooling line leads directly from the fuel tank to the mixing point with the leakage flow from the fuel injection valve, wherein a suction pump, for example, is arranged in the return line from the mixing point to the fuel tank, ensuring that the pressure prevailing in the return line is always lower than in the cooling line. The advantage with this embodiment is that the designer has the maximum amount of freedom in the arrangement of the cooling line.

Another illustrative embodiment of the fuel injection system is characterized in that the cooling line receives a volume flow required for fuel cooling from a return of the high pressure pump and feeds this volume flow to the leakage flow from the fuel injection valve via the mixing point. The advantage with this embodiment is that the return quantity from the high pressure pump provides a relatively large volume flow. In terms of design, it is possible here for an existing return line from the high pressure pump to be arranged in such a way that it connects the return to the mixing point, thus eliminating the need for any additional components.

A preferred illustrative embodiment of the fuel injection system is characterized in that the mixing point, at which the cooling line and the leakage from the fuel injection valves meet, is arranged as close as possible to the fuel injection valve. The advantage with this embodiment is that the short distance between the fuel injection valve and the mixing point means that the dwell time and the volume in the line system in which the fuel is exposed to a critical temperature are kept as small as possible, thus reducing the associated risks to a corresponding extent.

Another illustrative embodiment of the fuel injection system is characterized in that the cooling line receives a volume flow required for fuel cooling from a return line of the high pressure pump and that this volume flow can be divided by means of a restrictor or a valve in such a way that a partial quantity of the volume flow is fed to the mixing point through the cooling line for cooling and another partial quantity is connected directly via the return line of the high pressure pump to the fuel return to the fuel tank. The advantage of this embodiment is that the volume flow used for cooling through the cooling line can be regulated in an appropriate manner.

Another illustrative embodiment of the fuel injection system is characterized in that a sensor for temperature measurement or a sensor for flow measurement is arranged at the mixing point, thus enabling the volume flow through the cooling line to be regulated, by means of a variable restrictor or a valve for example, in such a way that a sufficient volume flow for cooling is fed to the mixing point through the cooling line at all times. This embodiment has the advantage that the volume flow fed through the cooling line is not unnecessarily high, precisely at relatively low system temperatures, and hence that the overall efficiency of the system is not unnecessarily reduced.

### BRIEF DESCRIPTION OF THE DRAWINGS

Illustrative embodiments of the invention are shown in the drawing and described in detail below:

In the drawing:

FIG. 1 shows a schematic representation of a fuel injection system in accordance with the prior art.

FIG. 2 shows a first illustrative embodiment of the fuel injection system according to the invention.

FIGS. 3 to 9 show further illustrative embodiments of the fuel injection system according to the invention in schematic representation.

### DETAILED DESCRIPTION

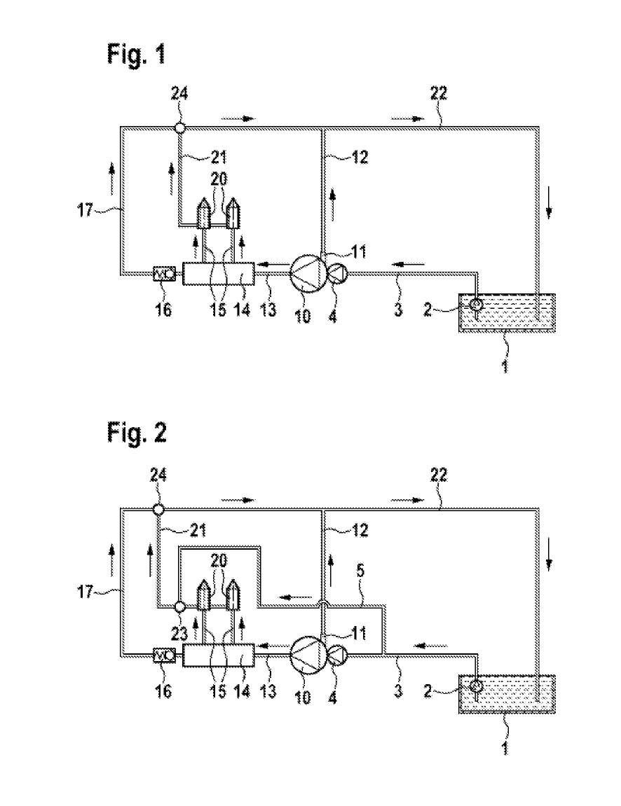

A high pressure injection system known from the prior art is illustrated schematically in FIG. 1. Fuel is fed from a fuel tank 1 to a pre-feed pump 4 and to a high pressure pump 10 via a connection line 3 by means of a fuel feed pump 2. The fuel tank 1, the fuel feed pump 2, the connection line 3 and the pre-feed pump 4 are subjected to low pressure and are therefore assigned to the low pressure region.

Arranged at the high pressure pump 10 is a fuel return 11, which is connected to the fuel tank 1 by a return line 12 and a further return line 22. Also leading away from the high pressure pump 10 is a high pressure line 13 to a high pressure reservoir 14, also referred to as a common rail, which is connected to the fuel injection valves 20 by further high pressure lines 15. The presence of a high pressure reservoir 14 is not absolutely essential here.

To operate an internal combustion engine (not shown), the fuel compressed by the high pressure pump 10 is injected into a combustion chamber by opening the fuel injection valves 20. Part of the fuel fed to the fuel injection valve 20 is relieved in the fuel injection valve 20 and enters as a control quantity or as a leakage quantity into the return line 21, which connects the fuel injection valve 20, possibly via a further return line 22, to the low pressure region described in paragraph 1, in particular to the fuel tank 1. In the schematic drawing, the direction of flow of the fuel is in each case indicated by arrows next to the corresponding lines.

Arranged at the high pressure reservoir 14 is a pressure limiting valve 16, which is connected by the return line 17 to a mixing point 24, at which the volume flows from the return line 17 from the pressure limiting valve 16 and the return line 21 from the fuel injection valve 20 meet and from where this volume flow passes into the fuel tank 1 via a further return line 22. If the pressure in the high pressure reservoir 14 rises above a maximum predetermined value, the pressure limiting valve 16 opens, and the excess pressure in the high pressure reservoir 14 is reduced by discharging fuel into the return line 17.

According to the present invention, a cooling line is used to add cooler fuel from the low pressure region to the leakage quantity from the fuel injection valve in order to reduce the temperatures in the return lines 21 and 22.

FIG. 2 shows a first illustrative embodiment of the high pressure injection system according to the invention, which contains an additional cooling line 5 as compared with the illustration in FIG. 1, said cooling line leading from the low pressure region of the injection system to a mixing point 23, at which the cooler fuel from the cooling line 5 is mixed with the fuel from the leakage of the fuel injection valve 20 and thus lowers the temperature in the return lines 21 and 22 accordingly. In this arrangement, the cooling line 5 is fed by the fuel feed pump 2, thus allowing the fuel to flow to the mixing point 23 through the cooling line 5. The fuel feed pump 2 is regulated in such a way here that a sufficient quantity of cooler fuel is delivered to the mixing point 23 through the cooling line 5 at all times. Moreover, the fuel feed pump 2 must be designed in such a way that the pressure in the connection line 3 and in the cooling line 5 is always higher than the pressure at the mixing point 23, thus giving the direction of flow according to the illustration in FIG. 2. The use of the fuel feed pump 2 eliminates the need for the pre-feed pump 4.

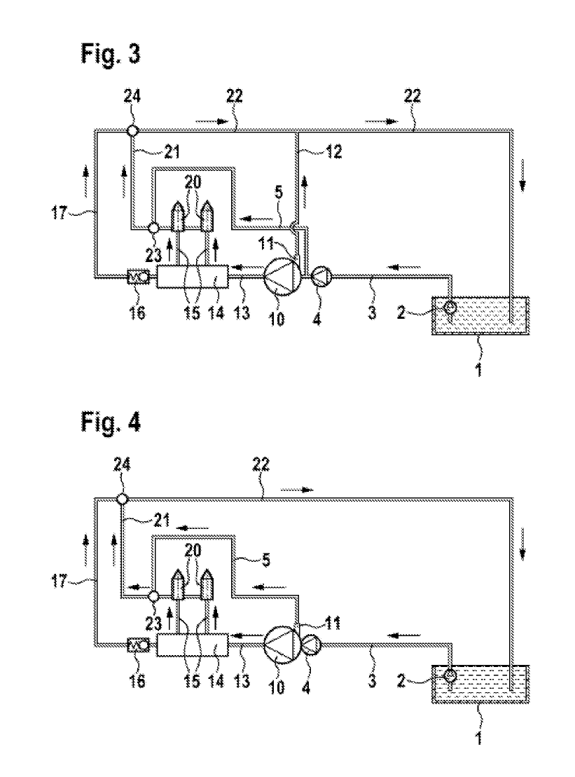

FIG. 3 illustrates another illustrative embodiment of the high pressure injection system according to the invention, in which the additional cooling line 5 is arranged between the pre-feed pump 4 and the mixing point 23, cooler fuel being pumped via said cooling line from the low pressure region to the mixing point 23, wherein the pre-feed pump must be designed in such a way that it produces a higher pressure than the pressure in the return line 21 in order to ensure the direction of flow from the mixing point 23, via the return lines 21 and 22, to the fuel tank 1. If the pre-feed pump 4 has sufficient suction to draw the fuel out of the fuel tank 1, the fuel feed pump 2 can be omitted.

FIG. 4 shows another illustrative embodiment, in which the cooling line 5 is arranged between the return 11 of the high pressure pump 10 and the mixing point 23 for the volume flows from the leakage of the fuel injection valve 20, wherein the return 11 of the high pressure pump 10 must be designed in such a way that the pressure prevailing in the return 11 is higher than the pressure in the return line 21 in order to ensure the direction of flow from the mixing point 23, via the return lines 21 and 22, to the fuel tank 1. In this embodiment, the return line 12 of the high pressure pump 10 is omitted. In this embodiment, either the fuel feed pump 2 or the pre-feed pump 4 can be omitted.

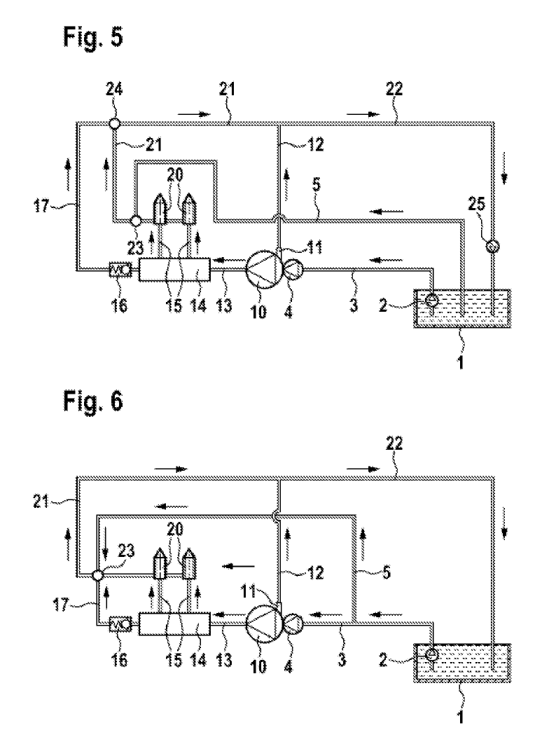

FIG. 5 shows another illustrative embodiment, in which the cooling line 5 is arranged between the fuel tank 1 and the mixing point 23. In addition, a vacuum pump 25 is arranged in the return line 22, wherein the vacuum pump 25 must be designed in such a way that the pressure prevailing in the return 21 and 22 is lower than in the cooling line 5 and at the mixing point 23, in order to ensure the direction of flow from the mixing point 23, via the return lines 21 and 22, to the fuel tank 1. In this embodiment, either the fuel feed pump 2 or the pre-feed pump 4 can be omitted.

FIG. 6 shows another illustrative embodiment, in which, as a departure from the illustration in FIG. 2, the return line 17 is arranged between the pressure limiting valve 16 and the mixing point 23, wherein the return line 17 can be made shorter than in the other illustrative embodiments.

FIG. 7 shows another illustrative embodiment, in which, as a departure from FIG. 4, the cooling line 5 is not fed directly from the return 11 of the high pressure pump 10 but the volume flow in the cooling line 5 is regulated by a valve 7 arranged in the return line 12 of the high pressure pump 10.

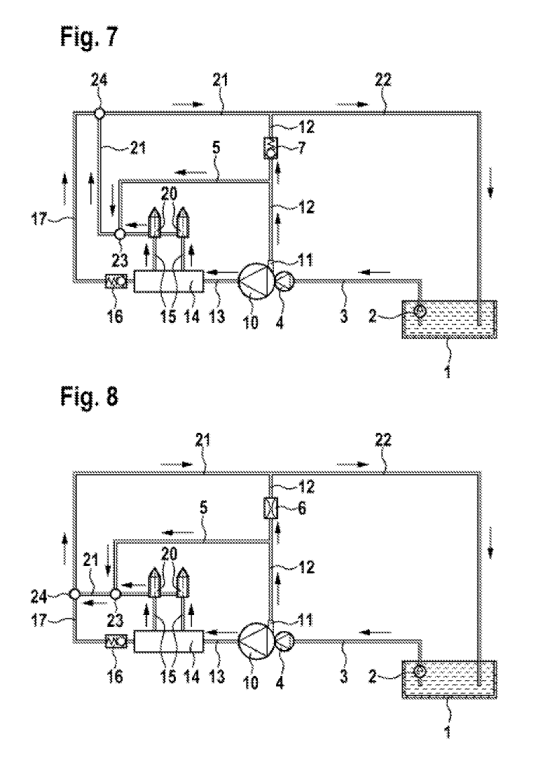

FIG. 8 shows another illustrative embodiment, in which, as a departure from FIG. 7, the volume flow through the return line 12 of the high pressure pump 10 is limited by a restrictor 6, thus ensuring that a sufficient volume flow reaches the mixing point 23 via the cooling line 5 at all times.

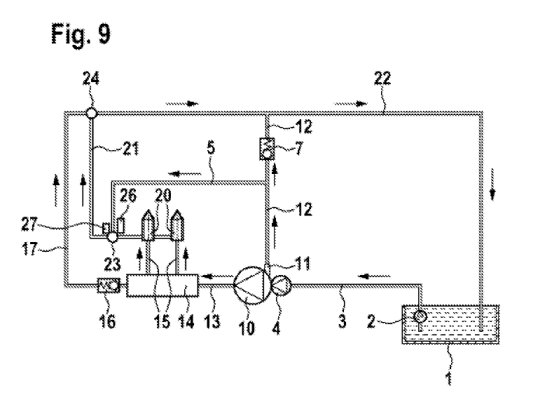

FIG. 9 shows another illustrative embodiment, in which, in addition to the illustrations in FIG. 7, a flow meter 26 is arranged between the fuel injection valves 20 and the mixing point 23 and a temperature sensor 27 is arranged at the mixing point 23, by means of which the flow rate through the cooling line 5 is regulated by way of the valve 7. This regulation can be performed either by way of both parameters (flow rate and temperature) or by way of one of the two parameters. The measuring element for the other measured variable can then be omitted. As an alternative to a valve 7 that can be regulated, it is also possible to use a variable restrictor 6 instead of the valve 7, as in FIG. 8.

1. A high pressure injection system having a fuel tank (1), a connection line (2, 3, 4) between the fuel tank (1) and a high pressure pump (10) for compressing the fuel, wherein the high pressure pump (10) is connected via a corresponding connection line (13, 14, 15) to at least one fuel injection valve (20), from which at least a partial quantity of the fuel compressed in the high pressure pump (10) is fed back into the fuel tank (1) via a return line (21, 22) connected to the fuel tank (1), through leakage in the fuel injection valve (20), characterized in that the high pressure injection system has a cooling line (5) that connects one of the fuel tank (1), the connection line (2, 3, 4), and a return (11) of the high pressure pump (10) to the return line (21, 22) via a mixing point (23).

2. The high pressure injection system as claimed in claim 1, characterized in that a connection line (2, 3, 4) contains a fuel feed pump (2), wherein the cooling line (5) is connected at one end to the connection line (2, 3, 4) between the fuel feed pump (2) and the high pressure pump (10) and is connected at the other end to the mixing point (23).

3. The high pressure injection system as claimed in claim 1, characterized in that a cooling line (5) leads from a pre-feed pump (4), which forms one element of the connection line (2, 3, 4) and which puts the fuel under pressure, to a mixing point (23).

4. The high pressure injection system as claimed in claim 1, characterized in that the connection lines (13, 14, 15) have at least the following components:
a high pressure reservoir (14), and
a pressure limiting valve (16) for pressure reduction at the high pressure reservoir (14),
wherein there is a return line (17) from the pressure limiting valve (16), wherein said return line (17) is connected at one end to the pressure limiting valve (16) at the high pressure reservoir (14) and is connected at the other end directly to one of the mixing point (23), and the return line (21, 22) via another mixing point (24).

5. The high pressure injection system as claimed in claim 1, characterized in that at least one of the following components is arranged in a return line (12) from the high pressure pump (10), between the high pressure pump (10) and the mixing point (23):
a restrictor (6), and
a valve (7),
wherein the component (6, 7) is suitable for directing at least a partial quantity of the volume flow out of the return (11) from the high pressure pump (10) or out of the return line (12) from the high pressure pump (10) into the cooling line (5) between said component (6, 7) and the mixing point (23).

6. The high pressure injection system as claimed in claim 1, characterized in that the mixing point (23), at which the cooling line (5) and the leakage flow from the fuel injection valve (20) meet, is as close as possible to the fuel injection valve (20).

7. The high pressure injection system as claimed in claim 1, characterized in that a vacuum pump (25) for producing a vacuum in the return line (21, 22) is arranged in the return line (21, 22) between the mixing point (23) and the fuel tank (1).

8. The high pressure injection system as claimed in claim 5, characterized in that at least one of:
a flow meter (26) is arranged between the high pressure injection valve (20) and the mixing point (23),
and a temperature sensor (27) is arranged at the mixing point (23),
the at least one of the flow meter (26) and the temperature sensor (27) being used to control the component (6, 7) in such a way that the flow rate through the cooling line (5) is regulated.

9. A method for operating a high pressure injection system having a fuel tank (1), a connection line (2, 3, 4) between the fuel tank (1) and a high pressure pump (10) for compressing the fuel, wherein the high pressure pump (10) is connected, via a corresponding connection line (13, 14, 15), to at least one fuel injection valve (20), from which at least a partial quantity of the fuel compressed in the high pressure pump (10) is fed back into the fuel tank (1) via a return line (21, 22) connected to the fuel tank (1), through leakage in the fuel injection valve (20), and having a cooling line (5) that connects one of the fuel tank (1), the connection line (2, 3, 4), and a return (11) of the high pressure pump (10) to a mixing point (23) of the return line (21, 22), characterized in that a higher pressure is maintained in the cooling line (5) than in the return line (21, 22) at all times.

10. The method for operating a high pressure injection system as claimed in claim 9, characterized in that a temperature in the cooling line (5) is lower than a temperature of the leakage quantity from the fuel injection valve (20), with the result that a temperature in the return line (21, 22) is reduced by the addition of the cooler fuel from the cooling line (5) at the mixing point (23).

11. The method for operating a high pressure injection system as claimed in claim 9, characterized in that a volume flow fed to the mixing point (23) via the cooling line (5) is sufficient to achieve a cooling effect on the leakage from the fuel injection valve (20) in the return line (21, 22).
